(19) United States
(12) Patent Application Publication
(10) Pub. No.: US 2006/0007477 A1
(43) Pub. Date: Jan. 12, 2006

(54) Storage medium storing computer program for presenting document registrant, document registrant presenting method, and document management apparatus

(75) Inventor: Akifumi Sekijima, Kawasaki-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/077,007

(22) Filed: Mar. 11, 2005

(30) Foreign Application Priority Data
Jul. 7, 2004 (JP) 2004-201117

(51) Int. Cl. G06F 15/00

(52) U.S. Cl. 358/1.15

(57) ABSTRACT

A document management apparatus includes, a document registration unit that registers a document therein, a document presenting unit that allows reference to a document registered to the document registration unit on the basis of a reference request from a user, a document reference history memory that stores reference history of a document, a document registrant memory that stores a registrant of a document, a score giving unit that, on the basis of reference history of a document belonging to a predetermined range corresponding to a predetermined item, gives a score to each registrant of the document, and a registrant presenting unit that selects and presents a registrant of the document on the basis of the cumulated given scores.

### BACKGROUND OF THE INVENTION

1. Field of the Invention

This invention relates to a document registrant presenting technique for presenting a user who is assumed to have predetermined knowledge from among document registrants, and particularly to a storage medium storing a computer program for presenting a document registrant, a document registrant presenting apparatus, a document registrant presenting method and a document management apparatus that can be suitably used for an information sharing system such as a document management system.

2. Description of the Related Art

It is known to provide a sharing system, a know-who search function is proposed that enables registration of users having expert knowledge to a database and search for an appropriate user by field of knowledge or by keyword. To construct such a know-who database, it is necessary to investigate users having knowledge in advance and total the evaluations among users.

As a technique that realizes know-who search without requiring the cost to construct a know-who database, it is known to provide a technique in which the state of web access by users and transmission and reception of mails are recorded and then a user who referred to a web page matching a keyword and a user who sent a mail matching a keyword are presented as users having predetermined knowledge.

However, since the above-described technique has no criteria for determining whether the content of the web page or mail in question is useful or not, a user extracted by this technique may not necessarily have predetermined knowledge.

### SUMMARY OF THE INVENTION

This invention has been made in view of the above circumstances and provides a technique of easily presenting a person who is expected to have predetermined knowledge.

According to an aspect of this invention, a storage medium storing a computer program for presenting a document registrant, the computer program being executed by a computer to perform a function, the function includes registering a document, allowing reference to the registered document on the basis of a reference request from a user, storing reference history of a documentand a registrant of a document, on the basis of reference history of a document belonging to a predetermined range corresponding to a predetermined item, giving a score to each registrant of the document, and selecting and presenting a registrant of the document on the basis of the cumulated given scores.

According to another aspect of this invention, a document registrant presenting method includes registering a document, allowing reference to the registered document on the basis of a reference request from a user, storing reference history of a document and a registrant of a document, on the basis of reference history of a document belonging to a predetermined range corresponding to a predetermined item, giving a score to each registrant of the document, and selecting and presenting a registrant of the document on the basis of the cumulated given scores.

According to another aspect of this invention, a document management apparatus includes, a document registration unit that registers a document therein, a document presenting unit that allows reference to a document registered to the document registration unit on the basis of a reference request from a user, a document reference history memory that stores reference history of a document, a document registrant memory that stores a registrant of a document, a score giving unit that, on the basis of reference history of a document belonging to a predetermined range corresponding to a predetermined item, gives a score to each registrant of the document, and a registrant presenting unit that selects and presents a registrant of the document on the basis of the cumulated given scores.

### BRIEF DESCRIPTION OF THE DRAWINGS

Embodiments of the invention will be described in detail based on the following figures, wherein:

FIG. 1 is a block diagram schematically showing a structure of a document management system according to an embodiment of this invention;

FIG. 2 is a view for explaining an example of reference history and user/group information in the embodiment;

FIG. 3 is a view for explaining an example of document attribute in the embodiment;

FIG. 4 is a view for explaining operation of a document registrant ranking totaling unit in the embodiment;

FIG. 5 is a view for explaining an example of user interface employed by a document registrant ranking condition designating unit in the embodiment;

FIG. 6 is a view for explaining an exemplary display of document registrant ranking in the embodiment; and

FIG. 7 is a view for explaining another exemplary display of document registrant ranking in the embodiment.

### DETAILED DESCRIPTION OF THE INVENTION

Hereinafter, an embodiment of this invention will be described.

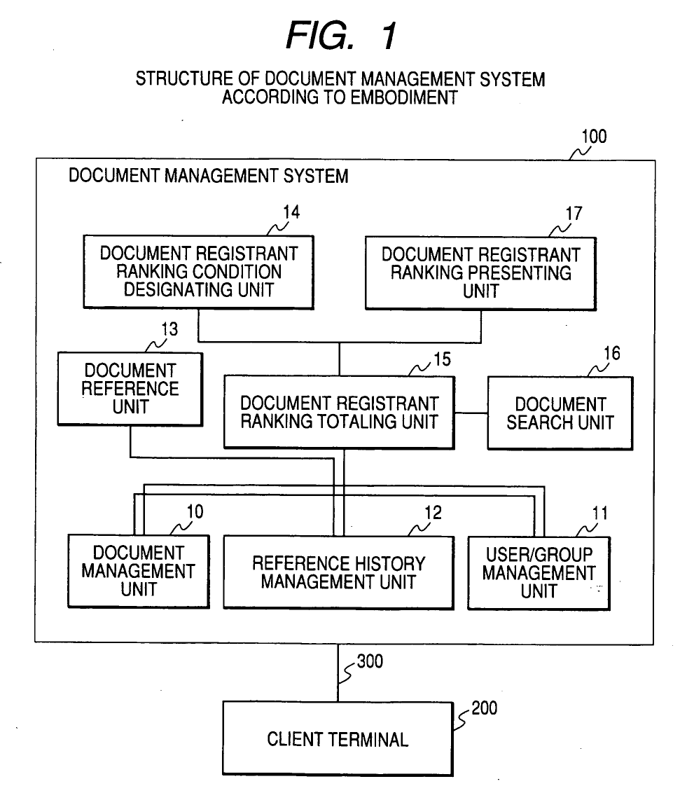

FIG. 1 shows an embodiment in which this invention is applied to a document management system. The document management system is constructed, for example, by installing a computer program for document management to a server computer via a storage medium or downloading. Using hardware resources such as CPU and external storage device and software resources of the server computer, each function (unit) of the document management system is realized.

In FIG. 1, a document management system 100 is connected to a client terminal 200 via a communication network 300. The client terminal 200 can send various requests to the document management system 100 and receive various services such as document registration, document browsing, and search. The document management system 100, as schematically shown, includes a document management unit 10, a user/group management unit 11, a reference history management unit 12, a document reference unit 13, a document registrant ranking condition designating unit 14, a document registrant ranking totaling unit 15, a document search unit 16, a document registrant ranking presenting unit 17 and the like.

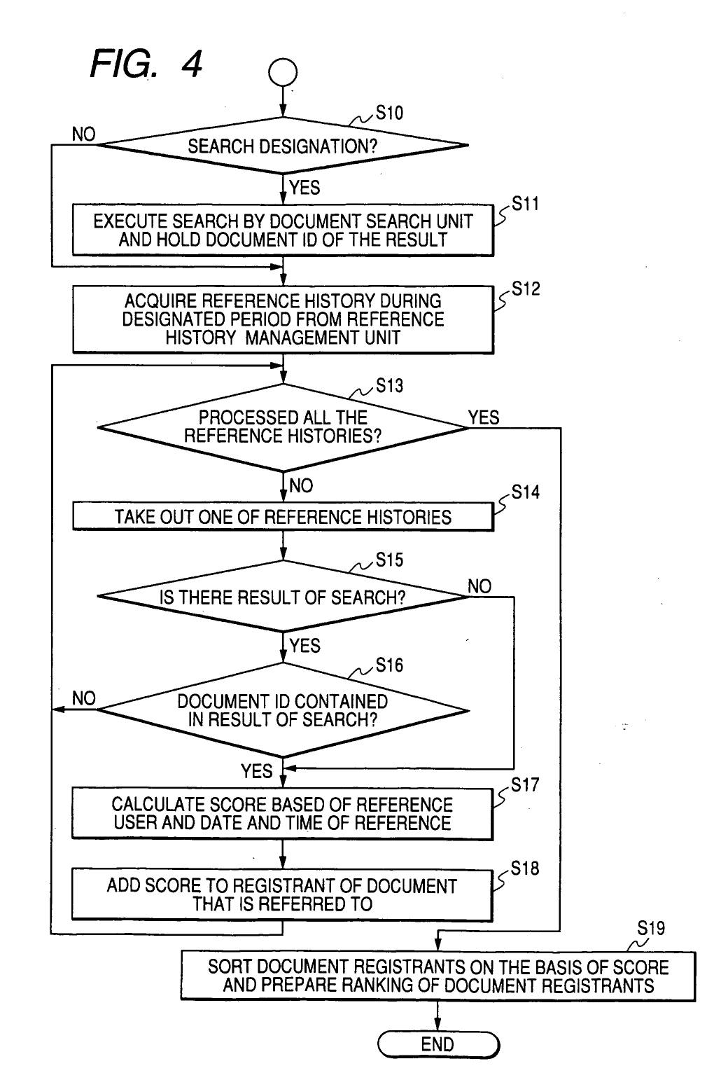

The document management unit 10 manages documents and their attributes. The attribute information of a document include document ID that univocally identifies the document and ID of a user who is a registrant of the documents, as shown in FIG. 3.

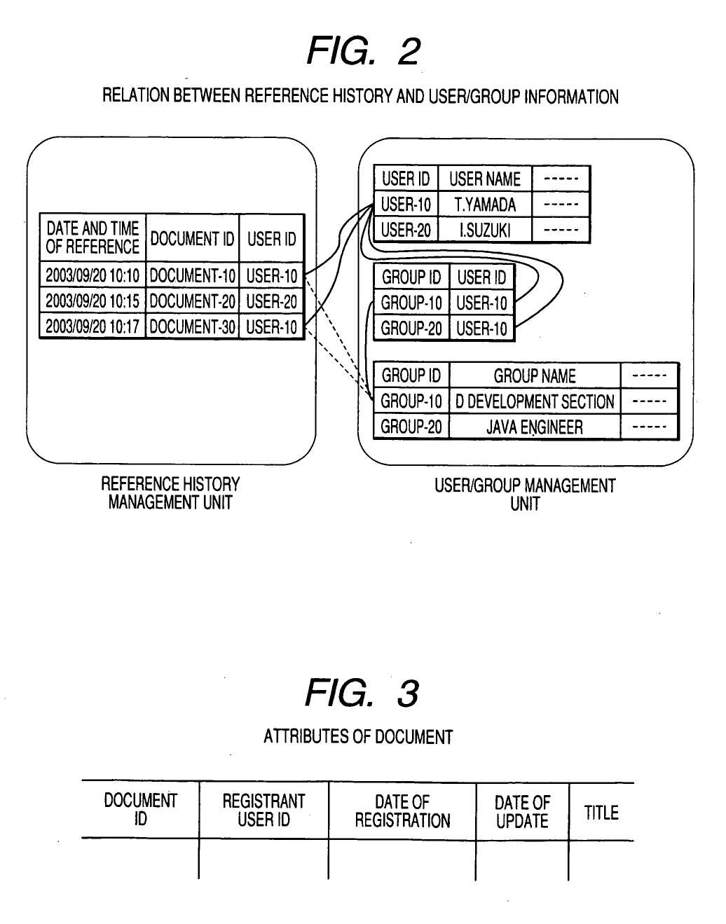

The user/group management unit 11 manages attribute information of users and groups and the relation between users and groups. The attribute information of users and groups include IDs that univocally identify the users and groups, as shown in the right section of FIG. 2. A user can belong to plural groups.

The reference history management unit 12 manages reference history of documents. The reference history information includes, for example, date and time of reference, document ID, and user ID, as shown in the left section of FIG. 2.

The document reference unit 13 acquires a document designated by a user from the document management unit 10 and presents it to the user. At this point, the document reference unit 13 prepares reference history and registers it to the reference history management unit 12.

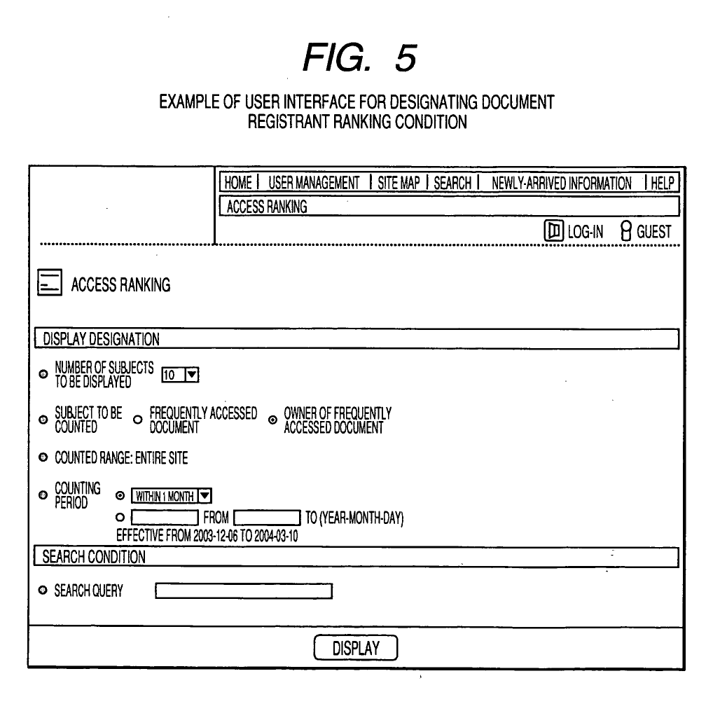

The document registrant ranking condition designating unit 14 designates conditions for displaying document registrant ranking. The conditions include, for example, designation of period to designate a target period in the reference history, and search designation to designate a keyword contained in a document and a category of document. The search designation is not essential. An example of user interface for designating the document registrant ranking conditions is shown in FIG. 5.

The document registrant ranking totaling unit 15 acquires reference history based on the designated conditions and totals the score on the document on the basis of scoring rules, which will be described later, to prepare document registrant ranking.

The document search unit 16 searches for a document on the basis of the designated search condition.

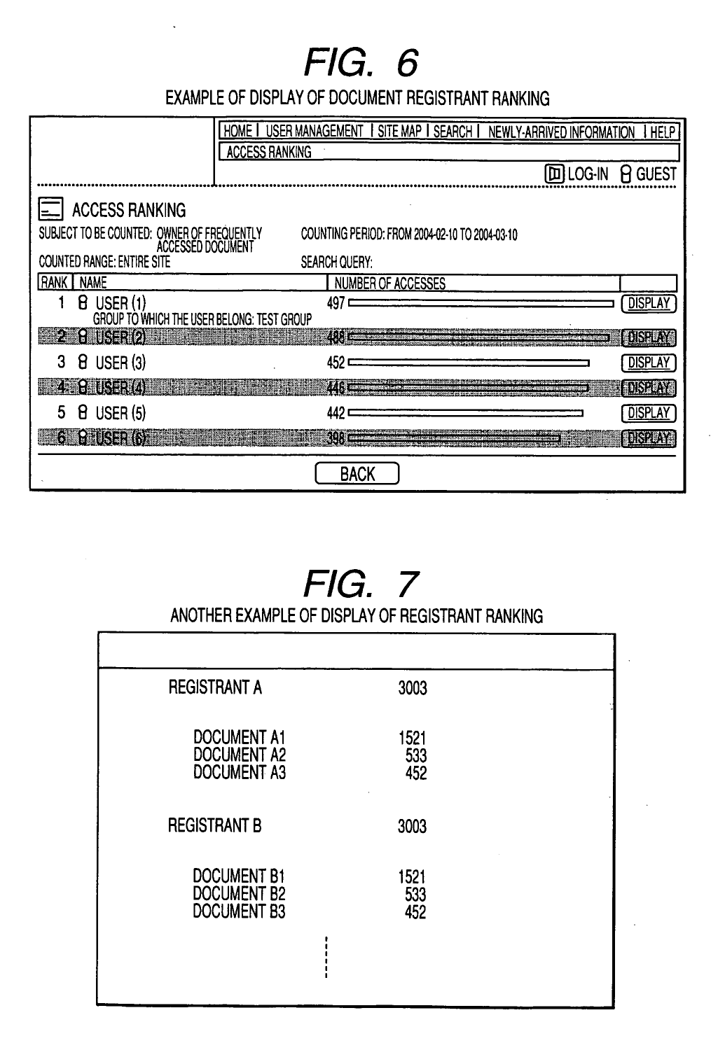

The document registrant ranking presenting unit 17 presents to a user the document registrant ranking prepared by the document registrant ranking totaling unit 15, for example, as shown in FIG. 6. In the example of FIG. 6, a display button is provided, and when this button is operated, a list of documents having higher scores of documents registered by the user is displayed. However, the presentation technique is not limited to this. While only the name of the user and the score are displayed during the ranking display in the example of FIG. 6, it is also possible to display documents having higher scores of the documents registered by the user in association with the name of the user, as a display item of each user (see FIG. 7).

The scoring rules, for the document registrant ranking totaling unit 15 to total the score on a document include the following.

(1) Reference by a User Belonging to the Same Group

The score given on a document that is referred to by a user belonging to the same group as a user who requested presentation of document registrant ranking is increased. Specifically, when finding the number of times of reference to each document from the reference history information, the number of times of reference is totaled by multiplying a coefficient that increases the value in the case where a user belonging to the same group refers to the document.

This makes it easier to find the registrant of the document to which a user belonging to the same group refers frequently, that is, a user who is very likely to have knowledge related to the business of the referring user.

(2) Reference by Various Users

The score on a document that is referred to by various users is increased. Specifically, after the number of times of reference to each document is found from the reference history information, the number of times of reference is totaled by multiplying a coefficient that increases the value more as the number of different users in the reference history information with respect to one document is larger. When the number of times of reference to each document is found from the reference history information, alternatively, the number of times of reference is totaled by multiplying a coefficient that decreases the value with respect to the user who refers to once.

This makes it easier to find the registrant of a generic and highly useful document that is referred to by more users.

(3) Reference Continued for a Predetermined Period

The score on a document that is referred to continuously for a predetermined period is increased. Specifically, when finding the number of times of reference to each document from the reference history information, it is judged whether or not the document is referred to for a week or a month from the date of registration, and if such reference is not made, a predetermined value is subtracted from the result of totaling and the number of times of reference is thus totaled.

These scoring rules may be combined with each other. It is also possible to enable selection of one of the scoring rules to be used for totaling, by the document registrant ranking condition designating unit.

Next, the processing by the document registrant ranking totaling unit 15 will be described with reference to FIG. 4.

The processing by the document registrant ranking totaling unit 15 is as follows.

In step S10, it is judged whether search designation is made or not. If it is made, the processing goes to step S11. If not, the processing goes to step S12.

In step S11, documents stored in the document management unit 10 are searched by the document search unit 16, and IDs of documents contained in the result of the search are held.

In step S12, reference history during a designated period is acquired from the reference history management unit 12. As is apparent from steps S15 and S16, if search is done, the reference history of documents contained in the result of the search becomes the subject. If search is not done, the reference history of all the documents becomes the subject. Alternatively, folders for individual fields may be provided and subject documents may be narrowed down by designating a folder.

In step S13, it is judged whether all the reference histories are processed or not. If all the reference histories are processed, the processing goes to step S19. If all the reference histories are not processed, the processing goes to step S14.

In Step S14, one of the reference histories is taken out and processed.

In step S15, it is judged whether there is a result of search or not. If there is not, the processing goes to step S17. If there is, the processing goes to step S16.

In step S16, it is judged whether the document ID is contained in the result of search or not. If not, the processing returns to step S13 to repeat the above processing. If the document ID is contained, the processing goes to step S17.

In step S17, weighting or the like is changed on the basis of reference user and date and time of reference, and the score is thus calculated.

In step S18, a score is added to the registrant of the document that is referred to, and the processing returns to step S13 to repeat the above processing.

In step S19, document registrants are sorted on the basis of their scores and ranking of the registrants is prepared.

As described above, according to an aspect of this invention, a storage medium stores a computer program for presenting a document registrant, the computer program being executed by a computer for realizing: a document registration unit that registers a document therein; a document presenting unit that allows reference to a document registered to the document registration unit on the basis of a reference request from a user; a document reference history storage unit that stores reference history of a document; a document registrant storage unit that stores a registrant of a document; a score giving unit that, on the basis of reference history of a document belonging to a predetermined range corresponding to a predetermined item, gives a score to each registrant of the document; and a registrant presenting unit that selects and presents a registrant of the document on the basis of cumulative score.

According to the embodiments, scoring on a document is performed by using history information about document reference by a user. Then, the score on the document is totaled for each registrant and, for example, the ranking of registrants is presented. Reference to a document by many users indicates a high probability that the document is important. It suggests that the registrant of this document is a person who has expert knowledge.

The “document management apparatus” may be a part of a predetermined system or apparatus. In short, what it is called does not matter as long as it has a function of presenting a document registrant.

The reference history of a document is history of access to the document. It is not limited to browsing or the like of the document and may include various types of reference such as downloading, copying, writing, commenting, and notification of recommendation of the document. In the case where the document involves plural versions or formats (original document, text document, summary and the like), reference to any of these versions and formats may be used.

As described above, some embodiments of the invention are outlined below.

According to the embodiments of this invention, scoring on a document is performed by using history information about document reference by a user. Then, the score on the document is totaled for each registrant and, for example, the ranking of registrants is presented.

In the embodiment of this invention, documents of higher ranks, which are registered by the user, are presented in association with the ranking of registrants of the document. This enables users of the system to know the reason for the ranking of registrants and to easily access highly useful documents.

In the embodiment of this invention, a history range selection unit that selects a range for the reference history may be provided. In this case, the score may be given on the basis of the reference history of the document by a user belonging to the same group as a user who makes a registrant presentation request. Alternatively, the score may be given on the basis of the reference history of the document during a designated period. The period is assumed to start at the time of registration of the document, but it is not limited to this. As a target type of reference, version, format or the like may be selected.

In the embodiment of this invention, the score may be varied by type of reference or by version or format of a reference target.

In the embodiment of this invention, a document search unit that searches for a document by keyword may be provided, and the document found by the document search unit may be assumed to be a document belonging to the predetermined range.

In the embodiment of this invention, in the case where documents of a predetermined field have been selected and registered in advance, it is not necessary to narrow down the selection by keyword search or the like.

In the embodiment of this invention, a list of at least documents of higher ranks, of documents registered by presented registrants, may be displayed. This list enables users to know the reason for the ranking of registrants and to easily access to highly useful documents.

This invention can be realized not only as an apparatus or system but also as a method. As a matter of course, a part of such an invention can be constructed as software. Also, a software product used for causing a computer to execute such software is naturally included within the technical scope of this invention.

This invention is not limited to the foregoing embodiments and various modifications and variations can be made without departing from the scope of the invention. For example, while the history of normal reference operations is described in the foregoing embodiments, the history of various types of reference such as downloading and update may be used.

The entire disclosure of Japanese Patent Application No. 2004-201117 filed on Jul. 7, 2004 including specification, claims, drawings and abstract is incorporated herein by reference in its entirety.

What is claimed is:

1. A storage medium storing a computer program for presenting a document registrant, the computer program being executed by a computer to perform a function, the function comprising:
registering a document;
allowing reference to the registered document on the basis of a reference request from a user;
storing reference history of a document and a registrant of a document;
on the basis of reference history of a document belonging to a predetermined range corresponding to a predetermined item, giving a score to each registrant of the document; and
selecting and presenting a registrant of the document on the basis of the cumulated given scores.

2. The storage medium storing a computer program being executed by a computer to perform the function as claimed in claim 1, wherein the function performed by the computer program further comprises selecting a range for the reference history.

3. The storage medium storing a computer program being executed by a computer to perform the function as claimed in claim 1, wherein the score is given on the basis of the reference history of the document by a user belonging to the same group as a user who makes a registrant presentation request.

4. The storage medium storing a computer program being executed by a computer to perform the function as claimed in claim 1, wherein the score is given on the basis of the reference history of the document during a designated period.

5. The storage medium storing a computer program being executed by a computer to perform the function as claimed in claim 4, wherein the period is assumed to start at the time of registration of the document.

6. The storage medium storing a computer program being executed by a computer to perform the function as claimed in claim 1, the function further comprising searching for a document by keyword, wherein the searched document is assumed to be a document belonging to the predetermined range.

7. The storage medium storing a computer program being executed by a computer to perform the function as claimed in claim 1, wherein a list of at least documents of higher ranks, of documents registered by the registrants, is presented.

8. A document registrant presenting method comprising:
registering a document;
allowing reference to the registered document on the basis of a reference request from a user;
storing reference history of a document and a registrant of a document;
on the basis of reference history of a document belonging to a predetermined range corresponding to a predetermined item, giving a score to each registrant of the document; and
selecting and presenting a registrant of the document on the basis of the cumulated given scores.

9. document registrant presenting method as claimed in claim 8, wherein the score is given on the basis of the reference history of the document by a user belonging to the same group as a user who makes a registrant presentation request.

10. The document registrant presenting method as claimed in claim 8, wherein the score is given on the basis of the reference history of the document during a designated period.

11. The document registrant presenting method as claimed in claim 10, wherein the period is assumed to start at the time of registration of the document.

12. The document registrant presenting method as claimed in claim 8, further comprising searching for a document by keyword, wherein the searched document is assumed to be a document belonging to the predetermined range.

13. The document registrant presenting method as claimed in claim 8, wherein a list of at least documents of higher ranks, of documents registered by the registrants, is presented.

14. A document management apparatus comprising:
a document registration unit that registers a document therein;
a document presenting unit that allows reference to a document registered to the document registration unit on the basis of a reference request from a user;
a document reference history memory that stores reference history of a document;
a document registrant memory that stores a registrant of a document;
a score giving unit that, on the basis of reference history of a document belonging to a predetermined range corresponding to a predetermined item, gives a score to each registrant of the document; and
a registrant presenting unit that selects and presents a registrant of the document on the basis of the cumulated given scores.

15. The document management apparatus as claimed in claim 14, wherein the score giving unit gives the score on the basis of the reference history of the document by a user belonging to the same group as a user who makes a registrant presentation request.

16. The document management apparatus as claimed in claim 14, wherein the score giving unit gives the score on the basis of the reference history of the document during a designated period.

17. The document management apparatus as claimed in claim 16, wherein the period is assumed to start at the time of registration of the document.

18. The document management apparatus as claimed in claim 14, further comprising a document search unit that searches for a document by keyword, wherein the searched document is assumed to be a document belonging to the predetermined range.

19. The document management apparatus as claimed in claim 14, wherein registrant presenting unit presents a list of at least documents of higher ranks, of documents registered by the registrants.
